(19) United States
(12) Patent Application Publication
(10) Pub. No.: US 2014/0026622 A1
(43) Pub. Date: Jan. 30, 2014

(54) METHODS AND APPARATUS FOR CONVECTIVE HEAT TREATMENT OF THIN GLASS SHEETS

(71) Applicant: Wenchao Wang, Ithaca, NY (US)

(72) Inventor: Wenchao Wang, Ithaca, NY (US)

(73) Assignee: Corning Incorporated, Corning, NY (US)

(21) Appl. No.: 14/111,008

(22) PCT Filed: Apr. 17, 2012
(86) PCT No.: PCT/US12/33867

§ 371 Date: Oct. 10, 2013

Related U.S. Application Data
(60) Provisional application No. 61/476,412, filed on Apr. 18, 2011.

(51) Int. Cl. C03B 29/16; C03B 35/20

(52) U.S. Cl. CPC C03B 29/16; C03B 35/205
USPC 65/111; 211/41.14

(57) ABSTRACT

Methods and apparatus for convective heat treatment of thin glass sheets (17) are provided. The glass sheets (17) are held in a fixture (9) which has a processing volume (19) which has an open top and an open bottom. A bottom support system (15) supports the bottom edges of the glass sheets (17) without blocking a substantial portion of the processing volume's open bottom. A side support system (13) holds the vertical edge regions of the glass sheets during the convective heat treatment, thus reducing vibration and distortion (warp) of the sheets as a result of the heat treatment. The side support system (13) can include vertical members (33) having arms (37) that can include lips (73) for engaging the major surfaces of the glass sheets (17).

This application claims the benefit of priority under 35 U.S.C.§119 of U.S. Provisional Application No. 61/476,412 filed on Apr. 18, 2011 the content of which is relied upon and incorporated herein by reference in its entirety.

### FIELD

This disclosure relates to methods and apparatus for convective heat treatment of thin glass sheets such as display-grade glass sheets. In one particularly beneficial application, the methods and apparatus are used to heat treat glass sheets prior to ion exchange strengthening.

### BACKGROUND

In display applications, glass sheets often need to be heat treated to improve or modify their properties. For example, manufacturers of glass sheets often heat treat glass sheets prior to shipping them to customers so that the sheets do not shrink or shrink very little when used in the customers' processes. Such heat treatments are known as “pre-shrinking,” “pre-compacting,” or simply “compacting.” These heat treatments differ from annealing in that they are performed at lower temperatures, e.g., temperatures below the strain point of the glass making up the sheets.

As one example of the need for pre-shrinking, the glass substrates used in the manufacture of liquid crystal displays, especially those employing poly-Si technology, are exposed to relatively high temperatures during the display manufacturing process. If not pre-shrunk, the substrates can undergo shape changes which are large enough to adversely impact the quality of the finished display. By pre-shrinking the glass sheets which form the substrates, the occurrence of this problem can be significantly reduced.

Recently, chemically strengthened glass sheets have become popular for use in the manufacture of faceplates and/or touch screens for mobile electronic products. For example, Corning Incorporated's GORILLA® glass has been widely-used for this purpose. In connection with the chemical strengthening of glasses of this type, it has been discovered that a heat treatment near the strain point of the glass prior to the chemical strengthening can significantly improve the glass' already high strength. See commonly-assigned U.S. application No. 61/422,812 filed on Dec. 14, 2010, and entitled “Heat Treatment for Strengthening Glasses,” the contents of which in their entirety are hereby incorporated herein by reference.

U.S. Pat. No. 7,363,777 and U.S. Patent Application Publication No. US 2007/0267312 disclose equipment that can be used in the heat treatment of glass sheets. Although the equipment and methods disclosed in these patent documents have worked successfully in practice, the focus of the technology disclosed therein has been on relatively slow heating and cooling of the glass sheets. Accordingly, the throughput achievable with these prior approaches has been limited.

The present disclosure addresses this low throughput problem. In particular, the disclosure provides methods and apparatus by which heat treatment of glass sheets can be performed in shorter times while still achieving low levels of warp and surface properties suitable for display and other demanding applications. Moreover, as discussed below, the methods and apparatus disclosed herein achieve more uniform thermal histories for the glass sheets which is beneficial for sheets that will be subjected to chemical strengthening subsequent to the heat treatment.

### SUMMARY

In accordance with a first aspect, a method is disclosed for heat treating glass sheets (17) that includes in order:

(a) holding a plurality of glass sheets (17) in a vertical orientation using a fixture (9) which includes:
(i) a box-shaped, open frame (11) which defines a processing volume (19) and has a top (25), a bottom (27), and first (21), second (21), third (23), and fourth (23) vertical sides, the first and second vertical sides (21) being on opposite sides of the frame (11);
(ii) a side support system (13) for the glass sheets (17) which includes a first set of vertical members (33,47) mounted to the frame's first vertical side (21) and a second set of vertical members (33,47) mounted to the frame's second vertical side (21), the first set of vertical members (33,47) forming a first set of glass-receiving spaces (61) which extend along the frame's first vertical side (21) and the second set of vertical members (33,47) forming a second set of glass-receiving spaces (61) which extend along the frame's second vertical side (21), the first and second sets of glass-receiving spaces (61) being aligned in pairs for receiving opposing edge regions of individual glass sheets (17); and
(iii) a bottom support system (15) for the glass sheets (17) which is mounted to the bottom (27) of the frame (11);

(b) passing a heating gas through the processing volume (19) and over the major surfaces of the plurality of glass sheets (17) to raise the temperature of the sheets to a treatment temperature Tₜᵣₑₐₜₘₑₙₜ; and

(c) passing a cooling gas through the processing volume (19) and over the major surfaces of the plurality of glass sheets (17) to lower the temperature of the sheets to a handling temperature T_{handling};

wherein:

(i) the glass sheets (17) have a width W1 at the handling temperature and a width W2 at the treatment temperature, W2 being larger than W1;

(ii) each glass-receiving space (61) has an inward end (63) and an outward end (65), the inward end (61) being closer to the opposing vertical side (21) of the frame (11) and the outward end (65) being farther from the opposing vertical side (21) of the frame (11);

(iii) the outward ends (65) of the first set of glass-receiving spaces (61) are separated from the outward ends (65) of the second set of glass-receiving spaces (61) by a distance O1 at the handling temperature and by a distance O2 at the treatment temperature, O2 being larger than O1;

(iv) the inward ends (63) of the first set of glass-receiving spaces (61) are separated from the inward ends (63) of the second set of glass receiving spaces (61) by a distance I1 at the handling temperature and by a distance I2 at the treatment temperature, I2 being larger than I1;

(v) the glass sheets (17) are heated in step (b) at a rate such that the glass sheets (17) reach Tₜᵣₑₐₜₘₑₙₜ before the frame (11) reaches Tₜᵣₑₐₜₘₑₙₜ;

(vi) the glass sheets (17) are cooled in step (c) at a rate such that the glass sheets (17) reach T_{handling} before the frame reaches T_{handling}; and

(vii) W1, W2, O1, and I2 satisfy the relationships:

O1>W2,

W2>I2, and

I2>W1.

In certain embodiments of the method according to the first aspect of the present disclosure, at room temperature, W1, O1, and I1 satisfy the relationships:

(O1−W1)/W1≧0.02, and

(W1−I1)/W1≧0.04.

In certain other embodiments of the method according to the first aspect of the present disclosure:

(i) the processing volume has an open top and an open bottom of areas Aₜₒₚ and A_{bottom}, respectively;
(ii) the bottom support system blocks gas passage through some but not all of A_{bottom}, the part of A_{bottom} that remains open for gas passage being at least 75 percent of A_{bottom};
(iii) in step (b), the heating gas is passed over the major surfaces of the glass sheets by using Aₜₒₚ and the open part of A_{bottom} to pass the heating gas through the processing volume;
(iv) in step (c), the cooling gas is passed over the major surfaces of the glass sheets by using Aₜₒₚ and the open part of A_{bottom} to pass the cooling gas through the processing volume; and
(v) the first and second sets of vertical members clamp the vertical sides of the glass sheets along substantially their entire lengths during the heat treatment so as to reduce vibration of the sheets as a result of the passage of the heating gas over the sheets' major surfaces.

In certain other embodiments of the method according to the first aspect of the present disclosure,

(i) each vertical member has a horizontal cross-section which includes two arms which extend into the processing volume and are horizontally splayed away from one another; and
(ii) the vertical sides of the glass sheets are clamped between the arms of adjacent vertical members.

In certain embodiments of the method according to the first aspect of the present disclosure, the arms of the vertical members comprise lips which make contact with the sheets' major surfaces.

In certain embodiments of the method according to the first aspect of the present disclosure, the vertical members are spaced horizontally from one another so that when not clamping a glass sheet, the arms of adjacent members make contact.

In certain embodiments of the method according to the first aspect of the present disclosure, the top portion of each arm of each vertical member is curved to guide glass sheets between adjacent vertical members.

In certain embodiments of the method according to the first aspect of the present disclosure, prior to step (a), the plurality of glass sheets are inserted into the frame using a robot which successively slides individual sheets into successive aligned pairs of glass-receiving spaces with the bottom of the sheet resting on the bottom support system.

A second aspect of the present disclosure is related to a method for heat treating glass sheets comprising:

(a) holding a plurality of glass sheets in a vertical orientation using a fixture which comprises:

(i) a box-shaped, open frame having a top, a bottom, and first, second, third, and fourth vertical sides, the frame defining a processing volume inside of the frame that has an open top and an open bottom of areas Aₜₒₚ and A_{bottom}, respectively,

(ii) a side support system for the glass sheets which comprises a first side support subsystem mounted to the frame's first vertical side and a second side support subsystem mounted to the frame's second vertical side; and

(iii) a bottom support system for the glass sheets which is mounted to the bottom of the frame; and

(b) subjecting the plurality of glass sheets to a heat treatment in which the temperature of the sheets is raised to within 50° C. below the strain point of the glass making up the sheets;

wherein:

(i) the bottom support system blocks gas passage through some but not all of A_{bottom}, the part of A_{bottom} that remains open for gas passage being at least 75 percent of A_{bottom};

(ii) the heat treatment comprises passing a heating gas over the major surfaces of the glass sheets by using Aₜₒₚ and the open part of A_{bottom} to pass the heating gas through the processing volume; and

(iii) the first and second side support subsystems clamp the vertical sides of the glass sheets along substantially their entire lengths during the heat treatment so as to reduce vibration of the sheets as a result of the passage of the heating gas over the sheets' major surfaces.

In certain embodiments of the method according to the second aspect of the present disclosure, the method further comprises an additional step after step (b) of passing a cooling gas over the major surfaces of the glass sheets by using Aₜₒₚ and the open part of A_{bottom} to pass the cooling gas through the processing volume.

In certain embodiments of the method according to the second aspect of the present disclosure, the method further comprises:

(i) the first side support subsystem comprises a first set of vertical members mounted to the frame's first vertical side;

(ii) the second side support subsystem comprises a second set of vertical members mounted to the frame's second vertical side;

(iii) each vertical member has a horizontal cross-section which includes two arms which extend into the processing volume and are horizontally splayed away from one another; and

(iv) the vertical sides of the glass sheets are clamped between the arms of adjacent vertical members.

In certain embodiments of the method according to the second aspect of the present disclosure, the arms of the vertical members comprise lips which make contact with the sheets' major surfaces.

In certain embodiments of the method according to the second aspect of the present disclosure, the vertical members are spaced horizontally from one another so that when not clamping a glass sheet, the arms of adjacent members make contact.

In certain embodiments of the method according to the second aspect of the present disclosure, the top portion of each arm of each vertical member is curved to guide glass sheets between adjacent vertical members.

In certain embodiments of the method according to the second aspect of the present disclosure, prior to step (a), the plurality of glass sheets are inserted into the frame using a robot which slides individual sheets into the first and second side support subsystems until the bottom of the sheet contacts the bottom support system.

In accordance with a third aspect, an apparatus is disclosed for holding a plurality of glass sheets (17) in a vertical orientation during a heat treatment including:

(a) a box-shaped frame (11) having a top (25), a bottom (27), and first, second, third, and fourth vertical sides (21,23), the first and second vertical sides (21) being on opposite sides of the frame (11);

(b) a support system (13) having a first set of vertical members (33) mounted to the frame's first vertical side (21) and a second set of vertical members (33) mounted to the frame's second vertical side (21), the first set of vertical members (33) forming a first set of glass-receiving spaces (61) on the frame's first vertical side (21) and the second set of vertical members (33) forming a second set of glass-receiving spaces (61) on the frame's second vertical side (21), the first and second sets of glass-receiving spaces (61) being aligned in pairs for receiving opposing edge regions of individual glass sheets (17) during use of the apparatus; and

(c) a bottom support system (15) mounted to the bottom (27) of the frame (11) which engages the bottom edges of glass sheets (17) during use of the apparatus;

wherein:

(i) each vertical member (33) has a horizontal cross-section which includes two arms (37) which are horizontally splayed away from one another;

(ii) each vertical member (33) of the first set of vertical members is mounted to the frame's first vertical side (21) with its arms extending towards the frame's second vertical side (21);

(iii) each vertical member (33) of the second set of vertical members is mounted to the frame's second vertical side (21) with its arms extending towards the frame's first vertical side (21); and

(iv) the first and second sets of glass-receiving spaces (61) are each formed by the arms (37) of adjacent vertical members (33).

In certain embodiments of the apparatus according to the third aspect of the present disclosure, the arms of the vertical members comprise lips which make contact with the sheets' major surfaces during use of the apparatus.

In certain embodiments of the apparatus according to the third aspect of the present disclosure, the arms of the vertical members make line contact with the sheets' major surfaces during use of the apparatus.

In certain embodiments of the apparatus according to the third aspect of the present disclosure, the vertical members are spaced horizontally from one another so that when not clamping a glass sheet, the arms of adjacent members make contact.

In certain embodiments of the apparatus according to the third aspect of the present disclosure, the top portion of each arm of each vertical member is curved to guide glass sheets between adjacent vertical members.

The reference numbers used in the above summaries of the various aspects of the disclosure are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as exemplified by the description herein. The accompanying drawings are included to provide a further understanding of the invention, and are incorporated in and constitute a part of this specification. It is to be understood that the various features of the invention disclosed in this specification and in the drawings can be used in any and all combinations.

### BRIEF DESCRIPTION OF THE DRAWINGS

FIG. 1 is a perspective view of an embodiment of glass handling apparatus constructed in accordance with the present disclosure.

FIG. 2 is a side view of the apparatus of FIG. 1.

FIG. 3 is a side view of the apparatus of FIG. 1.

FIG. 4 is a bottom view of the apparatus of FIG. 1.

FIG. 5 is a perspective view showing an individual glass sheet and its associated side support system.

FIG. 6 is a top view of the individual glass sheet and side support system of FIG. 5.

FIG. 7 is a side view of the individual glass sheet and side support system of FIG. 5.

FIG. 8 is a schematic side view from the inside of the apparatus of FIG. 1 illustrating guiding of a glass sheet into a side support system.

FIG. 9 is a plan view of a piece of sheet metal from which the vertical members of, for example, FIGS. 5-7 can be formed.

FIG. 10 is a side view of the piece of sheet metal of FIG. 9 after a first bending operation.

FIG. 11 is a perspective view showing a finished vertical member after further bending of the piece of sheet metal of FIG. 10.

FIG. 12 is a schematic diagram illustrating the application of a bending moment to glass sheets by a side support system having arms of different lengths.

FIG. 13 is a schematic diagram illustrating the use of lips to avoid the application of a bending moment to glass sheets by a side support system having arms of different lengths.

FIG. 14 is a plan view of a piece of sheet metal from which the vertical members of the type shown in FIG. 13 can be formed by bending.

FIG. 15 is a perspective view showing an individual glass sheet and its associated side support system in accordance with another embodiment of the present disclosure.

FIG. 16 is a schematic diagram illustrating the locations of the edge region of a glass sheet during a heating/cooling cycle for a side support system which uses arms without lips.

FIG. 17 is a schematic diagram illustrating the locations of the edge region of a glass sheet during a heating/cooling cycle for a side support system which uses arms with lips.

FIG. 18 is a schematic diagram illustrating the relative lengths of a glass sheet and the inward and outward ends of a glass-receiving space during a heating/cooling cycle.

The reference numbers used in the figures correspond to the following:
9 fixture
11 frame
13 side support system
15 bottom support system
17 glass sheet
19 processing volume
21 first vertical side (second vertical side)
23 third vertical side (fourth vertical side)
25 top
27 bottom
29 first side support subsystem
31 second side support subsystem
33 vertical member of side support system
35 leg
37 arm
39 curved portion of arm
41 bend line
43 bend line
45 bend line
47 alternate vertical member of side support system
49 lead-in lip
51 initial condition
53 glass-expands-more-than-frame condition as a result of rapid heat-up
55 frame-catches-up condition during heat-up
57 glass-cools-more-than-frame condition as a result of rapid cool-down
59 frame-catches-up condition during cool-down
61 glass receiving space
63 inward end of glass receiving space
65 outward end of glass receiving space
67 angle member
69 box member
71 flat
73 lip

### DETAILED DESCRIPTION

As indicated above, the present disclosure provides apparatus and methods for high throughput heat treatment of thin glass sheets, e.g., glass sheets having a thickness of 0.7 millimeters or less.

Among the challenges addressed and solved by the disclosed technology is the problem of warp of the glass sheets being processed. Warp is especially problematic for large and thin sheets (e.g., sheets having a thickness of 0.7 millimeters or less and opposing major surfaces whose individual areas are 0.25 m² or more) because the glass becomes fairly soft at the process temperature. The warp, if out of specification, not only is a quality issue for display-grade glass, but also creates a problem for downstream acid-etching processes.

In addition to warp, glass sheets used as substrates in display applications or as faceplates for mobile electronic devices need to have “quality areas” that meet rigorous standards with regard to surface blemishes (e.g., scratches) and contamination. Accordingly, conventional high throughput setups used, for example, with window glass, such as horizontal annealing on a conveyer belt, are not suitable for the heat treatment of glass sheets intended for use in these applications.

In accordance with the disclosure, it has been determined that to minimize warp and protect surface quality, the glass sheets need to be held in a vertical, straight-up orientation, with supports on the sheet's vertical edges. Also, the supporting apparatus needs to be dimensionally stable, so that it does not apply any twisting or bending forces to the glass sheets. Furthermore, to achieve high levels of throughput, the supporting apparatus needs to employ convective heating (and, optionally, convective cooling) so that the glass temperature can be rapidly raised to the processing temperature (and, optionally, rapidly lowered to a handling temperature, e.g., 40° C. or below). Along these same lines, robot-assisted glass loading and unloading is beneficial in order to increase productivity.

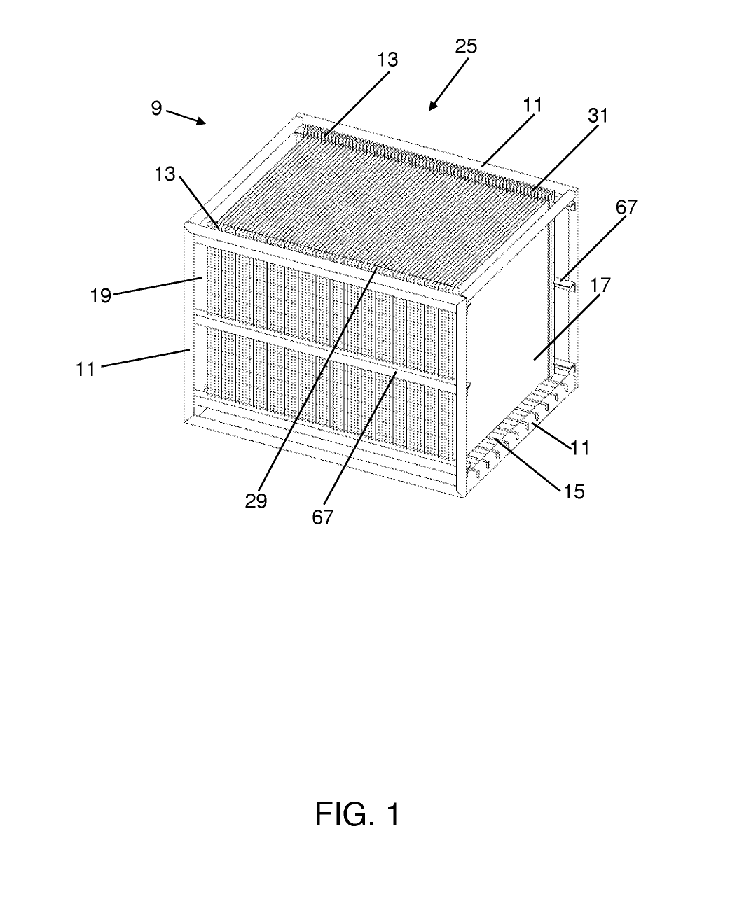

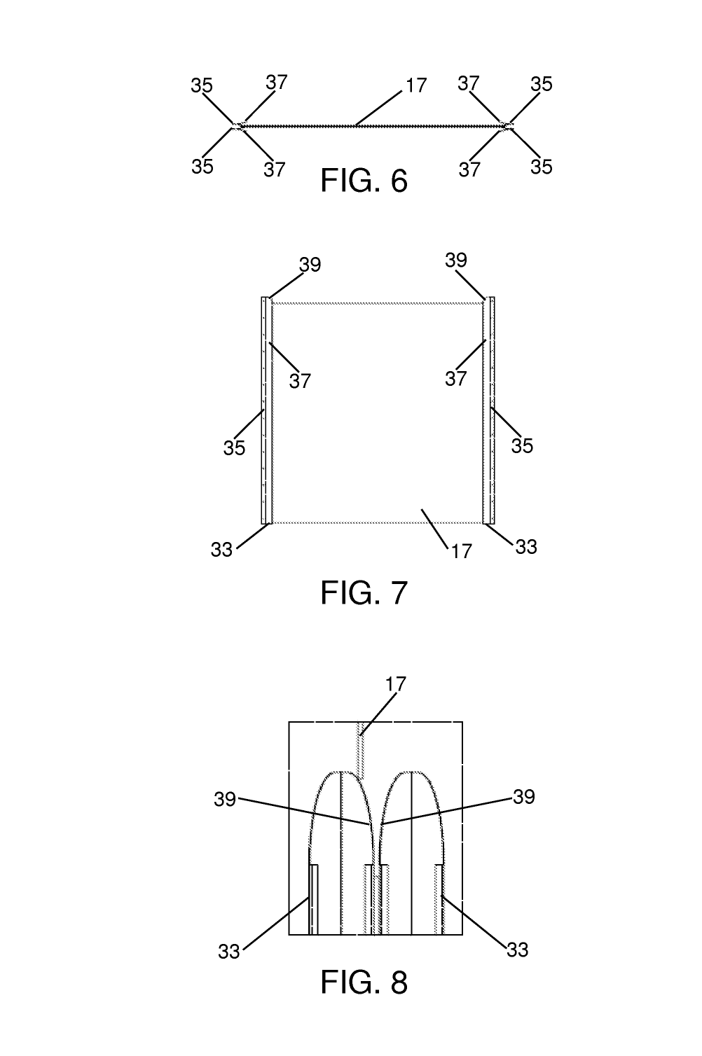

FIGS. 1-7 show an embodiment of a fixture 9 constructed in accordance with the principles of the present disclosure which achieves low warp, low surface damage, low surface contamination, and high throughput. The fixture is designed to hold a plurality of glass sheets (e.g., at least 50 sheets) during a heat treatment, such as a heat treatment prior to chemical strengthening of the glass sheets. As can be seen, the fixture has an open box construction, as opposed to a closed box construction of the type used in U.S. Pat. No. 7,363,777 and U.S. Patent Application Publication No. US 2007/0267312 referred to above.

The open box construction of fixture 9 enables convective heating and cooling, which is faster and more uniform than radiation heating/cooling. Tests on chemically-strengthened glass have shown that the beneficial compressive stress (CS) achieved by chemical strengthening is sensitive to the “thermal history” of the glass. Consequently, if part of the glass is heated at a higher temperature or at the same temperature but for a longer or shorter time, the CS in that part will be different from that in the rest of the sheet. At least to some extent, cooling differences can also affect the CS of chemically-treated sheets. Therefore, it is desirable to heat (and, optionally, cool) the entire load of glass sheets simultaneously and uniformly in order to avoid “thermal history” differentials. Compared to radiation heating (cooling), convective heating (cooling) using an open-box design is significantly better at meeting this requirement for substantially uniform thermal histories over the quality area of glass sheets.

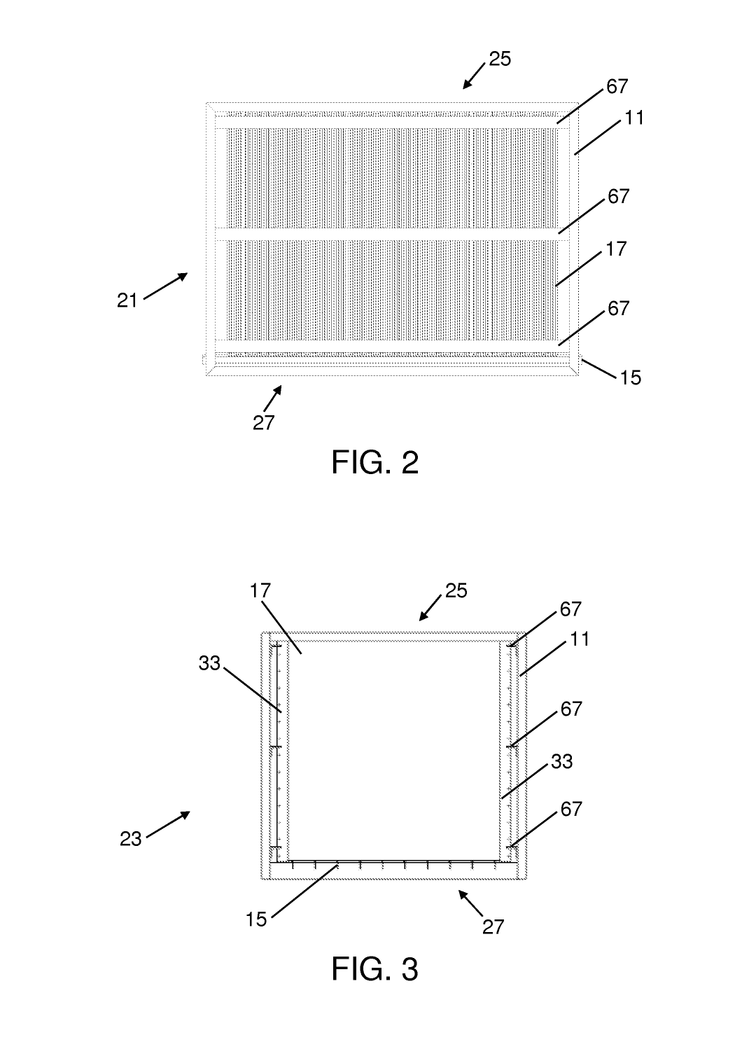

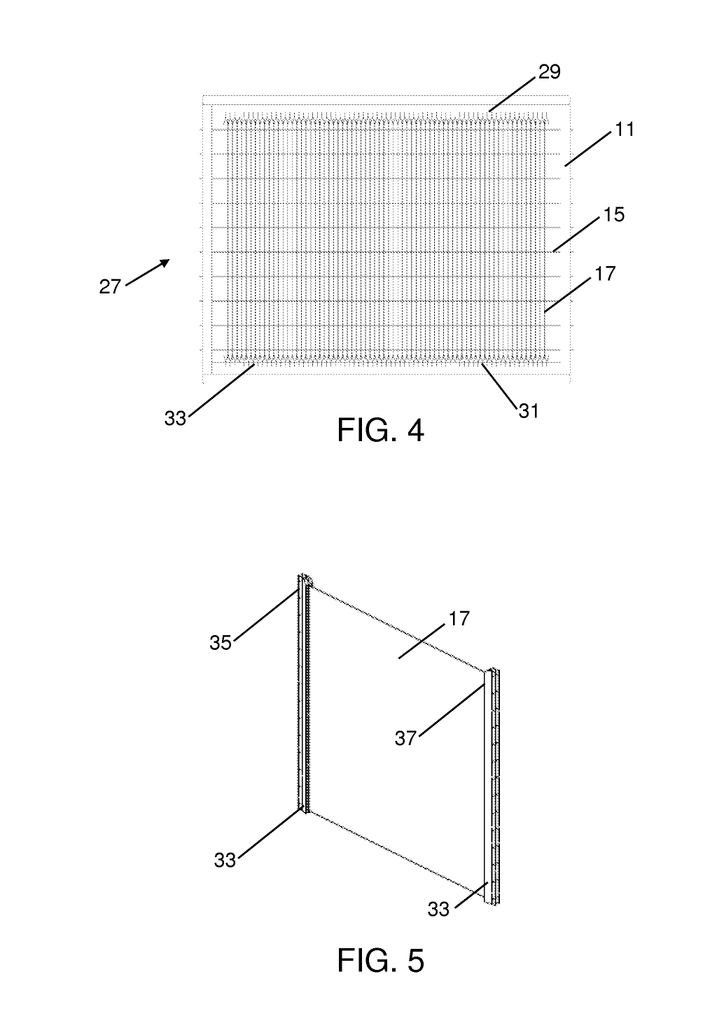

The convective heating (and convective cooling when used) is achieved by passing a heating gas (cooling gas) through the fixture. The heating gas (cooling gas) will typically be heated (cooled) air which has been filtered to remove particulates, although other gases can be used if desired. As shown best in FIGS. 1-4, fixture 9 includes a box-shaped, open frame 11 having a top 25 (see FIG. 1), bottom 27 (see FIG. 4), first and second vertical sides 21 (see FIG. 2), and third and fourth vertical sides 23 (see FIG. 3). In addition to its basic box structure, as shown in the figures, frame 11 can also include angle members 67 for stabilizing the frame's structure and for mounting the fixture's side support system to the frame (see below). The angle members can, for example, be welded to the frame.

The interior of frame 11 defines a processing volume 19 which has an open top of area Aₜₒₚ and an open bottom of area A_{bottom}. In the figures, Aₜₒₚ equals A_{bottom}, although in general, these areas can be different, e.g., larger frame elements can be used at the bottom of fixture 9 than at the top thus making Aₜₒₚ larger than A_{bottom}.

Fixture 9 includes bottom support system 15 (see FIGS. 1 and 4) which engages and supports the bottom edges of the glass sheets. In the figures, the bottom support system employs a plurality of vertical holding fins that are installed into slots cut into the bottom frame element. In use, glass sheets are inserted into frame 11 through its top and lowered down onto the holding fins, with the bottom edge of each glass sheet resting on the support fins. The bottom support system can employ other mechanisms for engaging the bottom edges of the glass sheets, e.g., a plurality of cables extending between the vertical sides of the frame can be used for this purpose. Whatever mechanism is used, it is important that the bottom support system does not substantially block gas flow through processing volume 19. In particular, the bottom support system should leave open for gas flow at least 75 percent of A_{bottom} (e.g., in one embodiment, 80 percent of A_{bottom} is left open).

To achieve rapid heating and, when used, rapid cooling, the gas flow through processing volume 19 needs to be quite high, e.g., on the order of, for example, at least 1 m³/s during heating and on the order of, for example, at least 1 m³/s during cooling. Such gas flows can result in vibration of the glass sheets being processed, and such vibration, in turn, can result in damage to the sheets. To reduce vibration of the sheets, fixture 9 includes side support system 13, which clamps the opposing vertical sides of the sheets along substantially their entire lengths. In particular, the side support system engages the vertical sides of the sheet with zero clearance. In addition to reducing sheet vibration, side support system 13 also minimizes warp by holding the edges of the glass sheets in place during the heat treatment. Because the heat treatment is conducted at a temperature close to the glass' strain point, e.g., within 50° C. of (below) the strain point (in one embodiment, within 20° C. of the strain point), the sheet can, at least to some extent, warp (distort) during the heat treatment. By simultaneously supporting the bottom of the sheet and holding its vertical sides fixed, the probability that such warp will become excessive is substantially reduced.

As shown in the figures, side support system 13 includes a first support subsystem 29 mounted to the first vertical side of frame 11 and a second support subsystem 31 mounted to the second vertical side of the frame. Each subsystem includes a plurality of vertical members (vertical fins) which form glass-receiving spaces for receiving edge regions of the glass sheets. The glass-receiving spaces can have various pitches, e.g., in one embodiment for use with glass sheets having a thickness of 0.7 millimeters, the pitch can be, for example, 10 millimeters.

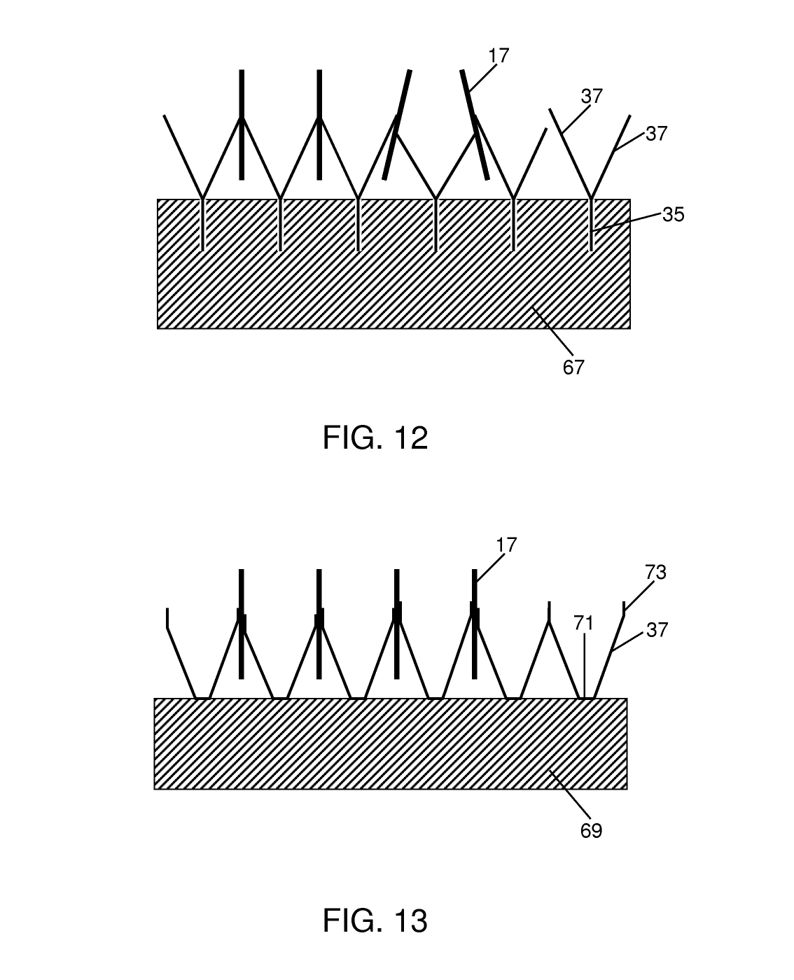

In the embodiments illustrated in FIGS. 1-14, the glass-receiving spaces are formed between adjacent vertical members 33 of the support system, while in the embodiment of FIG. 15, the glass-receiving spaces are formed within vertical members 47. In particular, in the embodiment of FIGS. 1-12, each vertical member includes a leg 35 and two arms 37 which are angled outward (splayed outward) from the leg, i.e., each vertical member has a horizontal cross-section in the form of a “Y”. As shown in, for example, FIG. 12, the vertical members can be mounted to frame 11 by inserting legs 35 into grooves formed in angle members 67. The legs can be welded (e.g., spot welded) to one or more of the angle members, e.g., to the middle angle member in the figures.

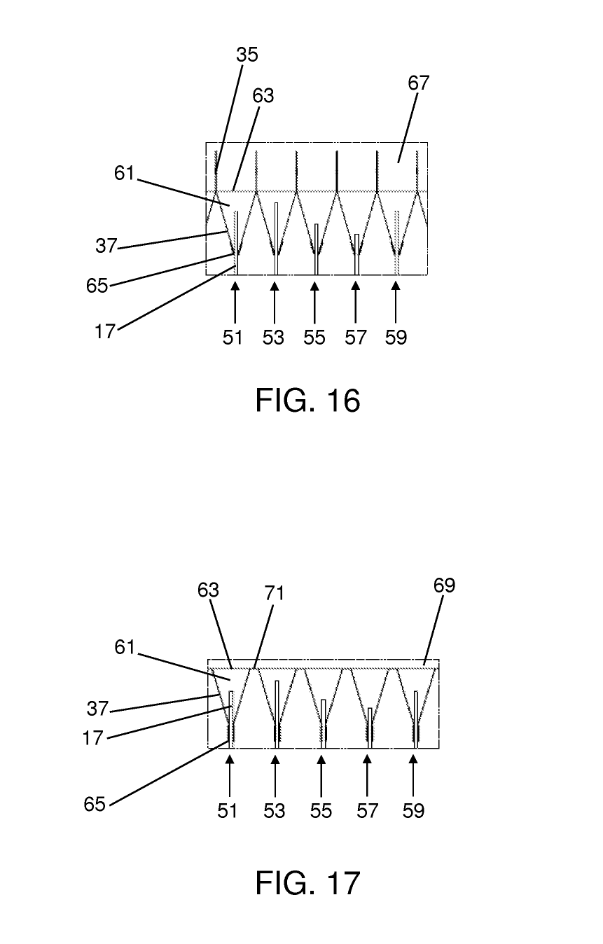

As can be seen in, for example, FIG. 5, adjacent vertical members function as “bookends” for a glass sheet, with the arms of the adjacent members making line contact with opposing major surfaces of the glass sheet inboard from the edge of sheet (in one embodiment, the line contact can be, for example, 10 millimeters inboard from the edge of the sheet). The glass-receiving space for the glass sheet is thus defined by the arms of adjacent vertical members and the inboard surfaces of angle members 67 (see, for example, FIG. 16).

In practice, variation in the lengths of arms 37 can apply a bending moment to glass sheets. This effect is illustrated in FIG. 12 where the fourth vertical member from the left has shorter arms and thus will tend to rotate glass sheet 17 inward when adjacent to a vertical member having a longer arm. As also illustrated in this figure, the arms of a given vertical member can be of different lengths, thus producing a gap with an adjacent arm (see the space between the right arm of the fifth vertical member from the left in FIG. 12 and the left arm of the sixth vertical member). These are, of course, fabrication errors that can be readily avoided in practice. However, to relax the fabrication tolerances, lips 73 can be added to the ends of the arms to accommodate variations in the lengths of the arms. Such lips are illustrated in FIG. 13. The vertical members of this figure include a flat 71 in place of leg 35. The flat can be welded to one or more box members 69 which can be used in place of angle members 67 when vertical members having flats, instead of legs, are used. Lips 73 can, of course, also be used with the Y-shaped vertical members of FIG. 12.

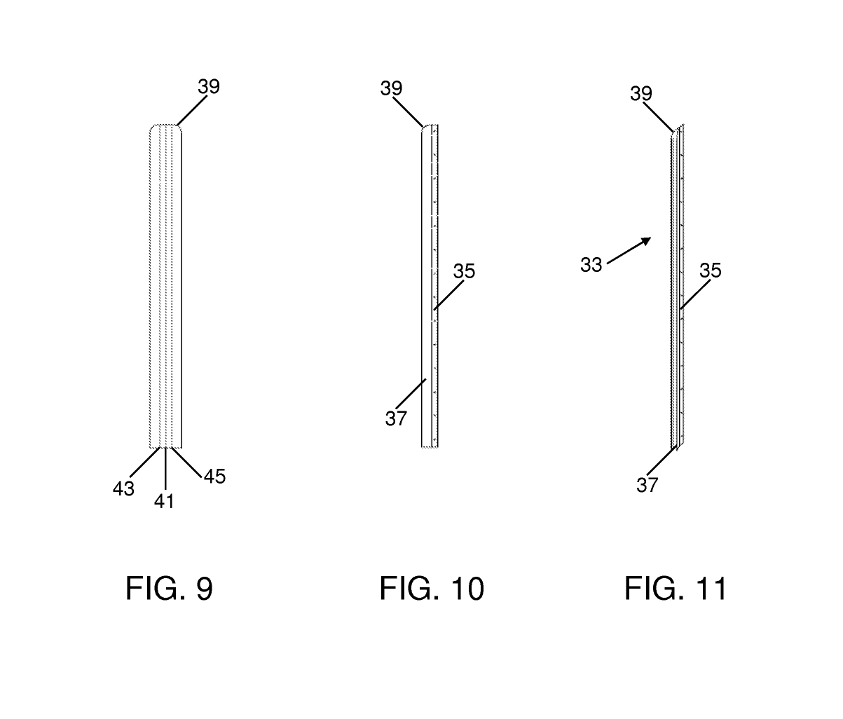

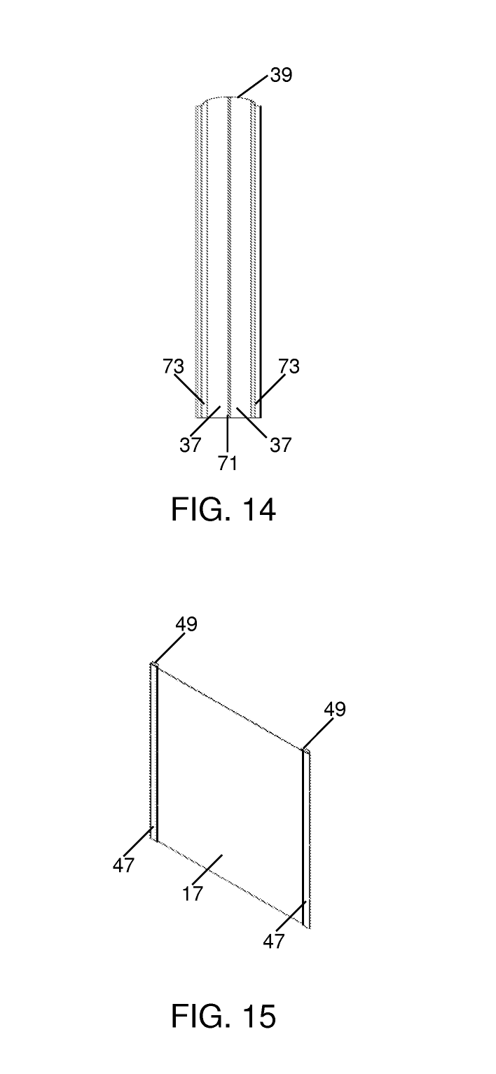

As illustrated in, for example, FIG. 8, the vertical members can include curved sections 39 for guiding glass sheets 17 into the glass-receiving spaces created by the vertical members. As illustrated in FIG. 9, such curves can be formed in, for example, a sheet metal blank from which the vertical member is formed. As can be seen from FIG. 9, using fold lines 41, 43, and 45, a Y-shaped vertical member can be readily formed from the blank, i.e., by first folding the blank along fold line 43 and then folding the blank along fold lines 43 and 45 to form leg 35 and arms 37, each of which has a curved portion 39. FIG. 14 illustrates a corresponding blank that can be used to form a vertical member which uses a flat 71 for mounting to frame 11 and includes lips 73 on arms 37 to ease fabrication tolerances. Although not illustrated in the figures, vertical members 47 of FIG. 15 can likewise be readily formed from, for example, a sheet metal blank. In this case, the vertical members include lead-in lips 49 for guiding the glass sheet into the body of the vertical member which forms the member's glass-receiving space. The lead-in lips can be formed by cutting the blank and folding the lips outward from the plane of the body of the member.

As noted above, the Y-shaped vertical members of FIGS. 1-12 make line contact with the opposing major surfaces of the glass sheets. The addition of lips to the arms of the vertical members results in strip contact, while vertical members of the type shown in FIG. 15 result in area contact. The extent of contact between the vertical members and the glass sheets affects the thermal history of the glass sheets. Specifically, regions of the glass sheets close to the points of contact will experience a different thermal history from regions distant from the points of contact. For many applications, the differences will not be large enough to affect a subsequent chemical strengthening procedure. However, in some cases, the differences may be important, in which case, a vertical member with lips may be more suitable than a vertical member of the type shown in FIG. 15. In still other cases, a vertical member which makes only line contact may be needed.

As also noted above, one of the advantages of the technology disclosed herein is the ability to rapidly heat and rapidly cool glass sheets, thus improving throughput. Such rapid heating and cooling can, however, result in glass breakage during heating and loss of control of the glass sheets during cooling. These problems arise because of the thinness of the glass sheets. Specifically, the glass sheets can reach the treatment temperature substantially before the frame reaches that temperature during heating and conversely, the sheets can reach the handling temperature substantially before the frame reaches that temperature during cooling.

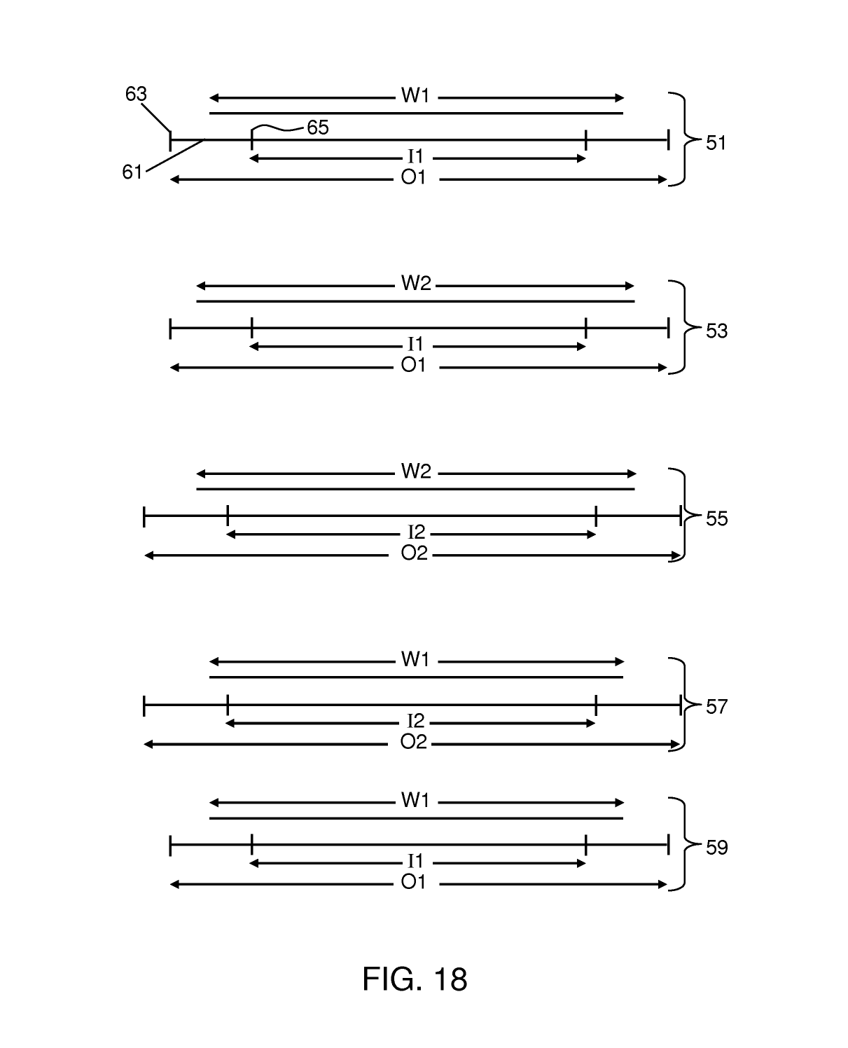

These effects are illustrated in FIGS. 16-18, where reference numbers 51, 53, 55, 57, and 59 illustrate, respectively: (1) the initial condition of the frame and glass sheets, (2) the greater expansion of the glass sheets relative to the frame during rapid heat-up; (3) the frame catching up to the glass sheets during heat-up; (4) the greater contraction of the glass sheets relative to the frame during rapid cool-down; and (5) the frame catching up to the glass sheets during cool-down. Also shown in these figures are the glass-receiving spaces 61 formed by the vertical members, the inward ends 63 of the glass-receiving spaces, and the outward ends 65 of the glass-receiving spaces. FIG. 18 further illustrates the widths W1 and W2 of the glass sheets at the handling and treatment temperatures, respectively, the distances O1 and O2 between the outward ends of the glass-receiving spaces at the handling and treatment temperatures, respectively, and the distances I1 and I2 between the inward ends of the glass-receiving spaces at the handling and treatment temperatures, respectively.

Quantitatively, at least to a first approximation, W1, W2, O1, O2, I1, and I2 are related by the expressions: W2=W1·(1+C_{glass}ΔT), O2=O1·(1+C_{frame}ΔT), and I2=I1·(1+C_{frame}ΔT), where C_{glass} is the coefficient of thermal expansion (CTE) of the glass, C_{frame} is the CTE of the material used to construct the frame, e.g., steel, and ΔT is the difference between the treatment and handling temperatures.

In order to avoid both breakage of the glass sheets as a result of contact with the outward ends of the glass-receiving spaces during rapid heat-up and loss of control of the sheets by the vertical members of the side support system during rapid cooling, W1, W2, O1, and I2 should satisfy the relationships: O1>W2, W2>I2, and I2>W1. In certain embodiments, O1 and I1 are selected to satisfy the relationships (O1−W1)/W1≧0.02, and (W1−I1)/W1≧0.04. In practice when these relationships are satisfied at room temperature (20° C.), the O1>W2, W2>I2, and I2>W1 relationships will be satisfied for most treatment and handling temperature combinations.

Various materials can be used to construct fixture 9. For example, frame 11, angle members 67 (when used), and box members 69 (when used) can be made of spring tempered austenite stainless steels, such as 304 or 301, or superalloys, such as INCONEL 718 or 625. The same types of materials can be used for the side and bottom support systems. The vertical members of the side support system can be made of sheet metal so that they are flexible and will function as springs for holding the glass sheets in place during the heat treatment. The spring function also allows a given fixture to be used with glass sheets of various thicknesses. Other materials capable of withstanding the temperatures and stresses associated with the heat treatment can, of course, be employed in constructing fixture 9 if desired.

During use, glass is loaded sheet-by-sheet into fixture 9 using, for example, a commercial robot. The loaded fixture is conveyed into a lehr equipped with a convection heating mechanism and subject to rapid heating followed by a holding period at a treatment temperature (Tₜᵣₑₐₜₘₑₙₜ). The rate of heating, the treatment temperature, and the duration of the holding period will, of course, depend on the specific glass being heat treated. As general guidelines, the heating rate can be in the range of, for example, 600-1200° C./hour, the treatment temperature can be in the range of, for example, 500-750° C., and the holding period can be in the range of 0.5-4 hrs.

After the heating, the fixture can be conveyed into a cooling chamber equipped with a convection cooling mechanism. Again, the rate of cooling and the temperature to which the glass sheets are cooled prior further processing (the handling temperature (T_{handling})) will depend on the specific glass being treated. As general guidelines, the cooling rate can be in the range of 600-1200° C./hour, and the handling temperature can be in the range of 20-50° C. After the cooling is completed, the glass is unloaded sheet-by-sheet from the fixture, e.g., using a robot, and transported to the next process step, e.g., to a chemical strengthening process.

As can be seen from the foregoing, the present disclosure provides practical apparatus for heat treating large and thin display-grade glass sheets at a temperature near the strain point of the glass. The heat treatment is performed without touching the majority of the glass surfaces (i.e., without touching the quality areas), thus avoiding scratches and contamination. The glass sheets are held in a vertical and straight-up position in order to minimize warp, and the vertical holding mechanism provides a damping effect in order to control damage due to glass vibration during convection heating/cooling cycles. In particular, the vertical holding mechanism can gently “nip” the glass (with zero clearance between the mechanism and the glass), so that the glass will have a better chance to be held in up-straight position and less chance to sag during the heating cycle.

The apparatus can hold many glass sheets in order to increase productivity and can ensure that all the sheets (and the entire quality areas of each individual sheet) are heated to the same temperature for the same duration, and cooled in the same manner to avoid variations in the final attributes of the glass sheets as a result of different thermal histories for different parts of the sheets.

The apparatus has an open-box design which is both simpler and lighter than prior apparatus used to hold glass sheets during heat treatments. The apparatus is thus simple yet functional, steady yet light, for cost effectiveness and operational efficiency. The apparatus is also dimensionally stable because its simple and light frame is less likely to suffer thermal distortion during heating and cooling cycles than more complex structures.

The apparatus is robot friendly and allows glass sheets to be automatically loaded/unloaded for increased productivity and reduced cost. In particular, the guiding feature at the top of the vertical members (the vertical holding fins) provides for easy insertion of the glass sheets. The box frame also facilitates positioning and indexing of the apparatus in robot loading/unloading operations.

A variety of modifications that do not depart from the scope and spirit of the invention will be evident to persons of ordinary skill in the art from the foregoing disclosure. The following claims are intended to cover the specific embodiments set forth herein as well as modifications, variations, and equivalents of those embodiments.

1. A method for heat treating glass sheets comprising in order:
(a) holding a plurality of glass sheets in a vertical orientation using a fixture which comprises:
(i) a box-shaped, open frame which defines a processing volume and has a top, a bottom, and first, second, third, and fourth vertical sides, the first and second vertical sides being on opposite sides of the frame;
(ii) a side support system for the glass sheets which comprises a first set of vertical members mounted to the frame's first vertical side and a second set of vertical members mounted to the frame's second vertical side, the first set of vertical members forming a first set of glass-receiving spaces which extend along the frame's first vertical side and the second set of vertical members forming a second set of glass-receiving spaces which extend along the frame's second vertical side, the first and second sets of glass-receiving spaces being aligned in pairs for receiving opposing edge regions of individual glass sheets; and
(iii) a bottom support system for the glass sheets which is mounted to the bottom of the frame;
(b) passing a heating gas through the processing volume and over the major surfaces of the plurality of glass sheets to raise the temperature of the sheets to a treatment temperature Tₜᵣₑₐₜₘₑₙₜ; and
(c) passing a cooling gas through the processing volume and over the major surfaces of the plurality of glass sheets to lower the temperature of the sheets to a handling temperature T_{handling};
wherein:
the glass sheets have a width W1 at the handling temperature and a width W2 at the treatment temperature, W2 being larger than W1;
(ii) each glass-receiving space has an inward end and an outward end, the inward end being closer to the opposing vertical side of the frame and the outward end being farther from the opposing vertical side of the frame;
(iii) the outward ends of the first set of glass-receiving spaces are separated from the outward ends of the second set of glass-receiving spaces by a distance O1 at the handling temperature and by a distance O2 at the treatment temperature, O2 being larger than O1;
(iv) the inward ends of the first set of glass-receiving spaces are separated from the inward ends of the second set of glass receiving spaces by a distance I1 at the handling temperature and by a distance I2 at the treatment temperature, I2 being larger than I1;
(v) the glass sheets are heated in step (b) at a rate such that the glass sheets reach Tₜᵣₑₐₜₘₑₙₜ before the frame reaches Tₜᵣₑₐₜₘₑₙₜ;
(vi) the glass sheets are cooled in step (c) at a rate such that the glass sheets reach T_{handling} before the frame reaches T_{handling}; and
(vii) W1, W2, O1, and I2 satisfy the relationships:
O1>W2,
W2>I2, and
I2>W1.

2. The method of claim 1 wherein, at room temperature, W1, O1, and I1 satisfy the relationships:
(O1−W1)/W1≧0.02, and
(W1−I1)/W1≧0.04.

3. The method of claim 1 wherein:
(i) the processing volume has an open top and an open bottom of areas Aₜₒₚ and A_{bottom}, respectively;
(ii) the bottom support system blocks gas passage through some but not all of A_{bottom}, the part of A_{bottom} that remains open for gas passage being at least 75 percent of A_{bottom};
(iii) in step (b), the heating gas is passed over the major surfaces of the glass sheets by using Aₜₒₚ and the open part of A_{bottom} to pass the heating gas through the processing volume;
(iv) in step (c), the cooling gas is passed over the major surfaces of the glass sheets by using Aₜₒₚ and the open part of A_{bottom} to pass the cooling gas through the processing volume; and
(v) the first and second sets of vertical members clamp the vertical sides of the glass sheets along substantially their entire lengths during the heat treatment so as to reduce vibration of the sheets as a result of the passage of the heating gas over the sheets' major surfaces.

4. The method of claim 1 wherein:
(i) each vertical member has a horizontal cross-section which includes two arms which extend into the processing volume and are horizontally splayed away from one another; and
(ii) the vertical sides of the glass sheets are clamped between the arms of adjacent vertical members.

5. The method of claim 1 wherein prior to step (a), the plurality of glass sheets are inserted into the frame using a robot which successively slides individual sheets into successive aligned pairs of glass-receiving spaces with the bottom of the sheet resting on the bottom support system.

6. Apparatus for holding a plurality of glass sheets in a vertical orientation during a heat treatment comprising:
(a) a box-shaped frame having a top, a bottom, and first, second, third, and fourth vertical sides, the first and second vertical sides being on opposite sides of the frame;
(b) a support system having a first set of vertical members mounted to the frame's first vertical side and a second set of vertical members mounted to the frame's second vertical side, the first set of vertical members forming a first set of glass-receiving spaces on the frame's first vertical side and the second set of vertical members forming a second set of glass-receiving spaces on the frame's second vertical side, the first and second sets of glass-receiving spaces being aligned in pairs for receiving opposing edge regions of individual glass sheets during use of the apparatus; and
(c) a bottom support system mounted to the bottom of the frame which engages the bottom edges of glass sheets during use of the apparatus;
wherein:
(i) each vertical member has a horizontal cross-section which includes two arms which are horizontally splayed away from one another;
(ii) each vertical member of the first set of vertical members is mounted to the frame's first vertical side with its arms extending towards the frame's second vertical side;
(iii) each vertical member of the second set of vertical members is mounted to the frame's second vertical side with its arms extending towards the frame's first vertical side; and
(iv) the first and second sets of glass-receiving spaces are each formed by the arms of adjacent vertical members.

7. The apparatus of claim 6 wherein the arms of the vertical members comprise lips which make contact with the sheets' major surfaces during use of the apparatus.

8. The apparatus of claim 6 wherein the arms of the vertical members make line contact with the sheets' major surfaces during use of the apparatus.

9. The apparatus of claim 6 wherein the vertical members are spaced horizontally from one another so that when not clamping a glass sheet, the arms of adjacent members make contact.

10. The apparatus of claim 6 wherein the top portion of each arm of each vertical member is curved to guide glass sheets between adjacent vertical members.
